(19) United States
(12) Patent Application Publication
(10) Pub. No.: US 2015/0195167 A1
(43) Pub. Date: Jul. 9, 2015

(54) AVAILABILITY DEVICE, STORAGE AREA NETWORK SYSTEM WITH AVAILABILITY DEVICE AND METHODS FOR OPERATION THEREOF

(71) Applicant: Horatio Lo, Milpitas, CA (US)

(72) Inventor: Horatio Lo, Milpitas, CA (US)

(21) Appl. No.: 14/587,765

(22) Filed: Dec. 31, 2014

Related U.S. Application Data
(60) Provisional application No. 61/923,472, filed on Jan. 3, 2014.

(51) Int. Cl. H04L 12/26; H04L 29/08

(52) U.S. Cl. CPC H04L 43/0817; H04L 67/1097

(57) ABSTRACT

The present invention discloses an availability device, a storage area networks (SAN) system with the availability device and methods for operating thereof. The SAN system with the availability device allows for topology changes in the SAN system due to regular maintenance and/or any unexpected component degradation event without disturbing the accessibility and availability of the data in the SAN system.

### CROSS-REFERENCE TO RELATED APPLICATIONS

Under 35 U.S.C. §119(e) this application claims the benefit of U.S. Provisional Application No. 61/923,472, filed on Jan. 3, 2014, the disclosure of which are incorporated herein in their entirety by reference.

### FIELD OF THE INVENTION

The present invention generally relates to the improvement of the accessibility and availability of data storage infrastructure for the purpose of business continuity. More particularly, the invention relates to an availability device, a storage area network (SAN) system with the availability device and methods for operation thereof.

### BACKGROUND OF THE INVENTION

Most SAN systems belong to the dedicated network category that provides access to consolidated block level data. SAN systems are primarily used to enhance the accessibility and availability of the data preserved in storage devices, such as disk arrays, tape libraries and optical jukeboxes, to the servers collaborating with the storage devices so that the storage devices appear to be locally attached devices to the servers or the operating system(s) within the servers in an enterprise situation. Therefore, a SAN system typically has its own network of storage devices that are generally not accessible through the local area network (LAN) by other devices. The lowered cost and complexity of SAN systems in the early 2000s allow wider adoption of SAN systems from the enterprise level to small businesses.

A basic SAN system includes three major components: a SAN switch, a plurality of storage devices and at least one server. High-speed cables with the fibre channel (FC) technology are used to connect the various components together. In most real-world situations, a SAN system includes many different switches, storage devices and servers, and it will likely also include routers, bridges and gateways to extend the scale of the SAN system. Therefore, the topology of a SAN system depends on its size and purpose, and the complexity of the topology of SAN systems has evolved as time goes by.

Storage virtualization technology is often adopted by SAN systems due to the significant storage capacity of SAN systems. Storage virtualization technology makes it possible to share storage capacity of all the storage devices in the SAN system. It also improves the mobility and availability of data in the SAN system. However, storage virtualization technology does not allow the SAN system to “keep well-function” for the situations of component degradation or component halt which may result from maintenance.

Server virtualization technology can share the integrated computing power from multiple servers and improve the availability of the integrated computing power. The remarkable computing power based on server virtualization technology is very suitable for a SAN system equipped with storage virtualization technology to construct an efficient working system for various business situations.

For a business that depends on information technology (IT) for ongoing operations, data accessibility and availability are the first priority. Thus, a SAN system with these two technologies is a potential solution to manage huge amounts of data. However, one cannot suspend any given component (e.g. RAID, switch, etc.) from the SAN system for offline maintenance on business hour, without disrupting the normal operations of the business services. For all storage systems, few risks are as destructive as a system outage. However, the storage system does go offline when a storage component fails, when a key node stops to work, or when a storage system change must be made. All these factors pose threats to the continuity of business operations.

In order to overcome the drawbacks in the prior art, an availability device, storage area network system with availability devices and methods for operation thereof are disclosed. The particular design in the present invention not only solves the problems described above, but is also easy to implement. Thus, the present invention has utility for the industry.

### SUMMARY OF THE INVENTION

The present invention discloses an availability device, which is concomitant with a SAN switch on a data path between servers and storage devices. It can provide data services by passing through some commands, according to the needs of the services being provided, and when the topology or the service status of any of the components of the SAN system is changed. More than that, the availability device can initiate additional commands by itself according to the needs of the services being provided. In addition, the disclosed availability device is a dedicated and purpose-built SAN system component that enables any SAN system components to be brought offline and/or later brought back online to the provided service for planned or unplanned maintenance during business hour without disrupting the ongoing service. It addresses the emerging need of “on-business-hour SAN maintenance services” by eliminating any service outages resulting from maintenance or unexpected events to the components of the SAN system. According to this concept, the Applicant discloses the contents of the present invention as follows.

In accordance with the first aspect of the present invention, an FC based availability device is adopted to construct the SAN system, which has improved data accessibility and availability. FCs are also used as the transmission medium between various components of the SAN system.

The disclosed SAN system includes a number of servers coupled with a number of storage devices via a number of SAN switches, wherein an availability device connects to the SAN switches, such that the availability device can communicate with the SAN switches to manage the various routes between the servers and storage devices. Through this management, the accessibility and availability between the servers and storage devices are implemented. An availability device includes a number of special purpose devices, called “availability engines”, which are clustered together to manage the storage devices mounted on the SAN system.

Each of the availability engines connects to two or more of the SAN switches to manage and control each of the routes, which are independent data paths between servers and storage devices. In the SAN system, an availability device synchronously replicates the data saved in a storage device on a logic unit (LU) to a different storage device on a different LU, wherein the original data and the replicated data are identical. An availability engine presents at least a pair of replicated data sets as a single data set to the servers connected to the SAN system.

When a component in the SAN system is brought offline due to regular maintenance or any unexpected component degradation, the availability device controls the SAN switches to re-route the independent data paths between the servers and the storage devices so that the servers can access the original or the replicated data set. Therefore, the data accessibility is achieved. In a situation where the offline component is a storage device or an LU, the availability device conducts the SAN switches to re-route the independent data paths that allow the servers to access the replicated data set. When a SAN switch is offline, the cluster of availability engines inside the availability device will guide the servers to access the original or the replicated data set via other SAN switches. If one availability engine is offline, its function will be performed by one of the other availability engines still remaining in the SAN system.

When one storage device or an LU is offline, the data set saved in it is offline as well. The SAN system continues operating as the servers keep reading and writing to the replicated data set. Writing new data to the replicated data set causes differences between the original and the replicated data set. The availability device keeps tracking and replicates the differences, therefore when the offline device comes back online, the availability device brings the offline device back into synchronization with the now-changed replicated data set according to the replicated differences. After the synchronization, the availability device re-routes the independent data paths again so that the workload balance of the SAN system is restored.

In addition, each of the availability engines is configured to verify that the SAN system is in fully functional status before taking any maintenance action. Each of the availability engines is also configured to verify that the offline component is in an allowable status before bringing the offline component back online.

To avoid any disruptions of the SAN system operation, re-routing a data path due to a component being offline or back online should require less than 15 seconds. Because the timeout values to server commands are typically in the neighborhood of 30 seconds, preferably, the present invention can construct a SAN environment in which one ordinarily skilled IT administrator can take any component out for maintenance, and bring it back online later, in an orderly manner and without disturbing the operation of the SAN system at all.

In accordance with the second aspect of the present invention, a SAN system is disclosed. The SAN system includes multiple components, the multiple components include at least one server; at least two storage devices containing unique configuration information and data information; at least two switches connected to the at least one server and the at least two storage devices to form multiple data paths from the at least one server and the at least two storage devices via each of the at least two switches; and an availability device including two availability engines, wherein each availability engine is connected to the at least two switches, configured to detect health conditions of the at least two storage devices and configured to control the at least two switches to allow the at least one server to access at least one of the at least two storage devices through at least one of the multiple data paths according to the health conditions.

In accordance with a further aspect of the present invention, a method for operating the SAN system of the second aspect of the present invention is disclosed. A method for operating the storage area network (SAN) system of the second aspect of the present invention to bring one of the components offline includes determining which one of the at least two storage devices should be brought offline and designating the storage device as a first device; detecting a health condition of the first device; detecting health conditions of the two availability engines; detecting health conditions of the at least two switches; detecting health conditions of connections between the two availability engines and the first device; detecting health conditions of connections between the two availability engines and at least one server; and recording the unique configuration information contained within the first device.

In accordance with yet another aspect of the present invention, a method for operating the SAN system of the second aspect of the present invention is disclosed. The method for the SAN system of the second aspect of the present invention to bring one of the components back online includes detecting a topology change in the SAN system; sending a notification to all components of the SAN system; recording the notification in any one of the two availability engines; and determining a new arrival port.

In the present invention, the ordinary skilled can understand that “engine” is a terminology in the software point of view. “Availability engine” can be replaced with “availability unit”, when it is described in the aspect of hardware. The above objectives and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 shows the topology architecture of a basic SAN system with the availability device.

FIG. 2 shows an embodiment when the availability engine tests the independent data path with input/output (I/O) from availability engine to one storage device via one FC switch.

FIG. 3 shows another embodiment when one availability engine tests the independent data path with I/O from the server side to the storage device side via one FC switch, and the other availability engine via the other FC switch.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for the purposes of illustration and description only; they are not intended to be exhaustive or to be limited to the precise form disclosed.

An availability device includes two or more clustered availability engines, so that the functions of the entire availability device will not be disturbed when any one availability engine is offline. A full parity protected data path, a redundant power supply, and self-diagnostic capability are required for each availability engine. Inside the availability device, the clustered availability engines communicate with each other through a standard SAN server-storage device interface. Structurally, the availability device has no back panel and so that an individual availability engine can be removed physically when necessary.

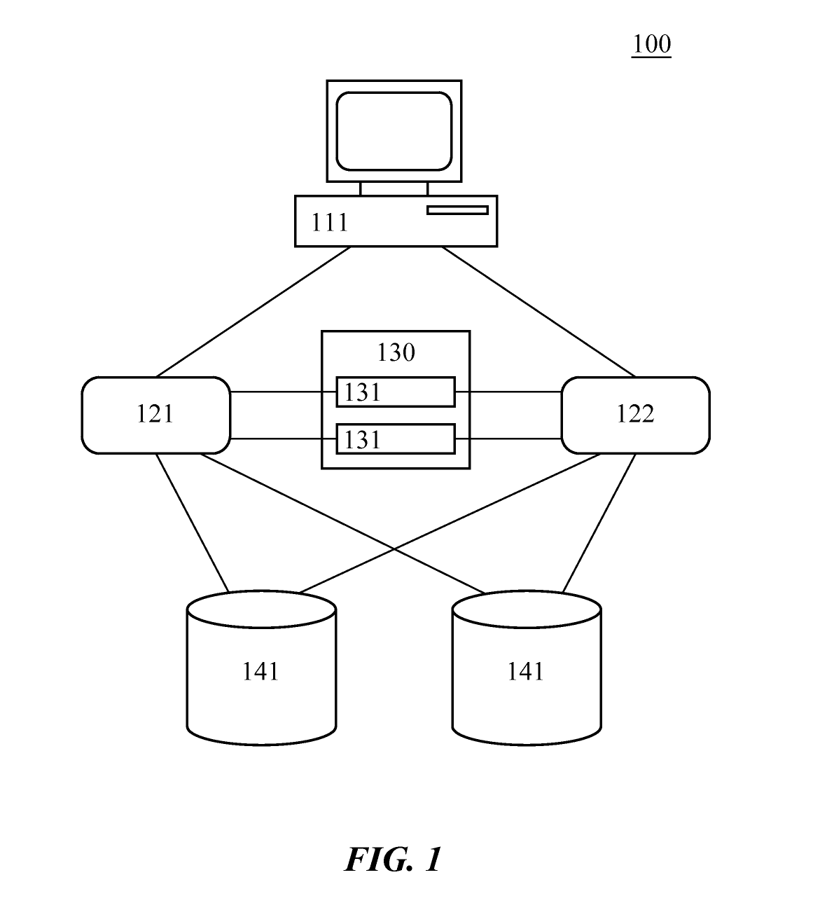

As shown as FIG. 1, the present invention is based on an availability device 130 with two or more clustered availability engines 131 and the availability device 130 is concomitant with the SAN system 100 having a standard and redundant configuration. At least one server 111 is connected to the dual and independent SAN switches 121 and 122, which are also connected to two or more dual-port storage devices 141.

To handle the event of any unexpected component behavior, one possible option is that an availability engine 131 performs a self-reboot as an attempt to recover from the event. Self-rebooting as part of the recovery (re-healing) process greatly improves the availability of the overall SAN system 100. The events which trigger the reboot will be properly logged and will be verified after recovery to prevent the availability engine 131 from having to reboot too often. The availability engine 131 halts itself when it detects continuous rebooting due to repeated failures (for the same cause). Because of the communication in the availability engine cluster, other availability engine(s) takes the workload from the halted availability engine to maintain the operation of the SAN system 100.

The event of regular maintenance and any unexpected component degradation may be some of the reasons that causes “unsupported behavior” or “unresponsive behavior”.

“Unsupported behavior” generally refers to when a request sent to an availability engine 131 by a server 111 attempts to invoke some function not implementable by the availability engine 131. The detection of an unsupported request is normally a straightforward matter. The availability engine 131 responds to the unsupported request being specified by the appropriate FC or small computer system interface (SCSI) standard document with a rejection. A well-behaved server 111 should realize that the function regarding its request is not supported by the availability engine 131 after at most a few rejections, and the well-behaved server 111 would stop sending the request. A poorly behaved server 111 may persist with sending the request. In extreme cases, a server 111 persists with sending the request for a prolonged period and/or at high frequency. The availability engine 131 may perform the following steps to log the server 111 out and not permit it to log back into the SAN system 100.

1. Receiving a request from a port with a world wide port name (WWPN) and determining whether the request is a unsupported request or not;
2. Responding to the request with a rejection and counting the number of times the request is made when request is an unsupported request, or executing the request when the request is not a unsupported request;
3. If the number of times is smaller than a predetermined N in the previous predetermined S seconds, performing step 1; if the number of times is larger than the predetermined N in the previous predetermined S seconds, logging out the server 111 sending the request and, adding the WWPN to a block list.

The “Unresponsive behavior” generally refers to when a port of a storage device or LU fails to return any response to a request within a reasonable period of time. In this situation, the port or logic unit will be considered to be unresponsive if the unresponsive behavior happens repeatedly. An unresponsive storage device or LU can definitely result in server operation failures. An availability engine 131 treats an unresponsive storage device the same way as it does a missing or failed device. This principle may also be applied to an unresponsive LU. The availability engine 131 satisfies server requests by providing access to the other responsive devices containing the same data set.

The availability engines 131 can distinguish excessive SCSI command timeouts from other cases of unresponsive behavior. The occurrence of the excessive SCSI command timeouts depends on many factors including the type of storage devices, the pattern, size and load of the server I/O and so on. In addition, there is a tradeoff to be made between identifying an unresponsive device or LU promptly and possibly declaring a failure prematurely (i.e. a “false trigger”). The availability engine 131 provides command-line interface (CLI) commands allowing the administrator to fine-tune the timeout interval, the definition of excessive SCSI timeouts and the response to excessive SCSI timeouts. Other unresponsive behaviors, such as a failure to reply to a login attempt or to a command abort request and so on, are relatively clear-cut with few variable factors. The availability engines 131 can handle these cases without any administrative input.

The firmware design for the availability engines 131 is based on what is known as “cooperative multitasking”. The heart of the system is a “main loop” that acts as a task dispatcher. Each function call within this loop activates the task associated with the function. The task executes until the function returns, and the next function in the loop is called. It is the responsibility of each task to execute for only a relatively brief time when it is activated. This is how the tasks cooperate to allow the availability engine 131 to run smoothly, by holding the central processing unit of the availability engine only briefly during each “time slice”. Nothing else enforces this cooperation.

Timing is crucial to most actions described above, and therefore each availability engine 131 has two timers. One is a software-based timer. The other is a hardware-based timer.

The software-based timer is implemented by using a periodic, general-purpose timer interrupt. Each time an interrupt occurs, a flag is set. The action in the main loop associated with this software-based timer is to clear the flag. The software-based timer is considered to have been in timeout if the interrupt occurs and the flag that was set by the previous interrupt has not been cleared.

The hardware-based timer is started prior to entering the main loop at initialization time. The entrance into the main loop restarts the timer. The hardware-based timer is in timeout if the timer ever expires.

Each of the availability engines 131 implements both software-based timers and hardware-based timers because they each has different advantages and disadvantages. The advantage of the software-based timer is that the software of the availability engine remains in control when the software-based timer sets off. That leaves enough time to allow the software of the availability engine 131 to determine how to react to the event of the timeout. Normally, that involves a reboot; however, the software in the availability engine 131 can elect not to reboot. When developing or testing the functions of a new availability engine 131, the cause of a timeout is more easily determined if the availability engine 131 doesn't reboot. Also, before rebooting, the software has the opportunity to log additional information about the state of the availability engine. This is important for effective diagnostic analysis. When the hardware-based timer sets off, that triggers an immediate reboot of the availability engine. If this is the case, the software has no control and has no opportunity to log any additional diagnostic information.

The disadvantage of the software-based timer is that if a problem occurs while interrupts are disabled, the software-based timer won't set off. That includes any problem that occurs inside of an interrupted service routine. The hardware-based timer is always functional. The two timers are set up such that the more useful software-based timer will be triggered first, but the hardware-based timer will set off if the software-based timer fails to do so. If the software-based timer does set off, the hardware-based timer is then disabled to prevent it from also setting off.

The availability engines 131 implement an in-band FCs “heartbeat” handshake between the availability engines 131 in the availability engine cluster. If an availability engine 131 goes offline, the other availability engines 131 are notified through the FCs about this event. However, it is possible for FCs to misbehave. There are also certain types of hardware failures that have been known to result in a port appearing to be reachable, when in fact it is not. The purpose of the heartbeat is to detect and deal with problems of this sort.

In addition to the FC heartbeat, availability engines 131 also implement a second heartbeat, the Ethernet-based heartbeat. The use of the Ethernet heartbeat is optional and is generally reserved for the cases when the availability engine cluster is spread over two or more sites or separated by a significant distance. In such cases, FC communications between sites are often routed through a single high-speed “pipe”. But a single failure can break this pipe, resulting in the isolation of the sites.

It is a very serious matter if two remote sites, each containing one or more availability engines 131 of the same availability engine cluster, become isolated. The availability engines 131 at each site continue to operate the mirrored LUs independently by using only the mirror member(s) located at its own site. When the isolation is corrected and the sites are rejoined, it is not possible to correctly re-synchronize the mirrored LUs. That leads to data corruption. This data corruption can be avoided by having the isolated sites to cease operation until they are rejoined or given instructions by the administrator.

When developing and testing the functions of a new availability engine 131, the self-recovery reboot function is typically turned off. This is because analyzing the problem is more important than recovering from the problem. In the end-user environment, this is not the case. However, gathering as much information as possible about the problem is still important.

The availability engines 131 generate ASCII-formatted, time-stamped diagnostic messages describing significant events and actions. These messages make up what is referred to as the “debug stream”. The messages in the debug stream are grouped into approximately 20 categories such as the driver for each FC port, engine-to-engine messaging and the dynamic random access memory (DRAM) block allocation and release. If desired, the debug stream can be directed in realtime to the availability engine 131's serial port, or to a telnet session. The debug stream also passes through a large ring buffer that preserves the most recent information. The contents of the debug stream buffer can be “replayed” at any time to the serial port or to a telnet session.

Prior to rebooting, the availability engine 131 saves the contents of the debug stream buffer, as well as a stack trace and much of other important information about the state and history of the availability engine 131 and the SAN system 100. Once the availability engine returns to normal operation after rebooting, there are multiple methods to retrieve the contents of this “core dump” for analysis. It can be automatically “pushed” to a pre-configured FTP server, manually “pulled” by an FTP client, or played out to the serial port or to a telnet session. Saving the core dump does not significantly add to the availability engine's reboot time.

It isn't possible to create a “full” core dump due to the immediate reboot caused by a hardware-based timer timeout. A very limited core dump (containing the debug stream buffer, but little else) is created after the engine completes its reboot. A power loss event also creates a very limited core dump after power is restored. To accomplish this, the debug stream is preserved in a non-volatile ring buffer. Unlike the main debug stream buffer (in DRAM), the contents of this buffer can survive a power loss.

Many of the functions of an availability device 130 require that the availability engines 131 of the availability engine cluster closely coordinate their actions. When a new availability engine 131 is added to the availability engine cluster, it automatically receives various kinds of information about the state of the availability engine cluster from existing availability engines 131. The new availability engine 131 will not attempt to execute any I/O requests from server applications until it is synchronized with the rest of the cluster. The same is true for an availability engine 131 which returns to the cluster after having been offline. It must re-synchronize with the cluster and update any events that occurred while it was rebooting.

Each possible cause for self-reboot has an unique numeric code associated with it. One of the things saved in each core dump is a history of the date/time/code information for recent self-reboots. An analysis of this history is performed each time a self-reboot occurs. If it is determined that the criteria for a “repeated failure” have been met then instead of rebooting again, the availability engine will take itself offline and remain offline until it is instructed to reboot by the administrator. An availability engine 131 will also take itself offline rather than rebooting if any self-reboot is detected less than one minute after the engine is powered on or rebooted for whatever reason.

At initialization, an availability device 130 can replicate data from a selected physical storage device(s) to others so that two or more identical data sets are created. The result is that any physical storage device 141 may then be brought offline for maintenance without interrupting the access of the data set to the server(s) 111.

When the servers 111 read from a mirrored LU, an availability device 130 reads data from any available physical storage device 141 containing the data set. The load may be balanced to all copies for improved performance. In cases where the storage systems have unequal read performance, one or more “preferred members” for read may be specified.

When a server 111 writes to a mirrored LU, an availability device 130 synchronously writes the data to all physical storage devices 141 that may include the equivalent mirrored LUs, thus maintaining the integrity of all data sets. The status for the write command is not returned to the server 111 giving the command until the data has been successfully written to all present and healthy mirror members.

To create a mirrored LU, first step is to assign a LU into the mirrored LU structure. The mirrored LU structure consists of mirrored LU identification (ID) and mirrored LU members. This assigned LU is the initial member of the mirrored LU. And, the mirrored LU at this point has single member. It forms a single member mirrored LU. Additional members may be subsequently added. The initial member is assumed to contain the data to be initially presented by the mirrored LUs. By default, when a new member is added, synchronization of the new member is started, in which every block of data is copied from an existing member that is already “in-synchronization”. One availability engine 131 is chosen by the availability engine cluster to perform all of the reads and writes needed to complete the synchronization of the new arrival member. If the new arrival member or the mirrored LU(s) encompassing the new arrival member will be reformatted before it is accessed by any server application, the initial synchronization may be skipped.

During synchronization, reading from one LU is directed to an in-synchronization member of the mirrored LU. The member being synchronized is not read. Writing to the mirrored LU is sent to all members, including the one being synchronized. It is necessary to prevent the collisions during synchronization writing and any overlapping writing sent to the mirrored LU by a server 111. This is illustrated by the following example:

1. Logical block address (LBA) X in member A is read (synchronization read);
2. A write is received from a server 111 to LBA X of the mirrored LU (member B);
3. The server 111's data for LBA X is written to the mirrored LUs (members A and B)
4. The data for LBA X in member A that was read is written to member B (synchronization write).

Members A and B now contain different data for LBA X. Member A correctly contains the new data received from the server 111, while member B incorrectly contains older data.

This sequence of events must be prevented from occurring. To accomplish this, before the availability engine performs the synchronization, the availability engine 131 sends a message to all engines of the cluster to request that LBA X be locked. All availability engines 131 inhibit the sending of any new write commands to LBA X. Once any already sent write commands to LBA X are complete, each engine sends a message back to the synchronizing engine acknowledging that LBA X is now locked. The synchronizing engine proceeds with the copy of LBA X from member A to member B without risk of a collision. Once the write to member B is complete, the synchronizing engine sends a new lock request for LBA X+1, which also serves as an unlock request for LBA X. Note that this example is simplified. What is typically locked, read and written is not a single LBA X, but rather a range of LBAs (X-Y).

The synchronization is generally throttled, rather than being done as quickly as possible. This is so that the performance of the server access to the mirrored LU is not severely impacted. As a result, initial synchronization generally takes many hours (or even days for very large LUs). If the data path for the process to the availability engine 131 to perform synchronization becomes unavailable, the cluster must choose another availability engine 131 to complete it. Clearly, starting over from LBA 0 would be undesirable. To prevent this, each availability engine 131 tracks the lock messages. If an availability engine 131 is called on to take over a synchronization task, this information can be used to determine the LBA where the process should resume.

When one of the physical storage devices 141 needs to be brought down for maintenance, the availability device 130 reads from and writes to the other storage devices 141 that contain the same data set, and keeps track of the changes to the data set for the storage device that is offline.

When the storage device 141 being serviced is brought back online, the availability device may re-synchronize just the changes to the data set by reading the changed data from an intact copy of the data set and writing to the returned storage device, or at the discretion of the administrator, may re-synchronize the entire storage device, in the same manner as an initial synchronization.

When a member of the mirrored LUs first drops out of the synchronization, a partial re-synchronization may be desired. One availability engine 131 is designated to track the changes to the data for the re-synchronization of the member of the mirrored LUs. All availability engines 131 are informed of this process.

For as long as one LU remains offline, writing to its mirrored LU is handled in a special way. Clearly it is not possible to write to the offline LU. Therefore, each availability engine 131 sends a message containing the metadata for the write command to the designated availability engine. The designated availability engine preserves the metadata by using a bitmap in the random access memory.

Once the offline member returns, the designated availability engine 131 begins the partial re-synchronization process based on the information in the bitmap. In general, only the changed blocks have to be copied, although in some cases it may be more efficient to also copy a few unchanged blocks. For example, LBAs N to N+4 are changed, N+5 is unchanged and N+6 to N+9 are also changed, thus it is probably better to copy N through N+9 rather than the two smaller fragments. The same issue of the collisions between synchronization writing and overlapping writing exists, and the same solution can be applied.

Because only the designated availability engine 131 knows the metadata for a partial re-synchronization, the metadata is unavailable if the designated availability engine 131 becomes unavailable any time between when the member of the mirrored LUs goes offline and when it returns. In such a case, the partial re-synchronization is not possible, and a full re-synchronization must be performed. This is avoidable if other methods of preserving the metadata are used. One option would be to store the metadata on disk somewhere where all availability engines can access it. Another option would be to designate primary and secondary change-tracking availability engines 131, to send the metadata messages to both, and to back each other up.

To enable the components of the SAN system 100 to be brought down for maintenance without disturbing server applications, monitoring and diagnostic processes to support and enforce a change control process are essential.

A monitoring process is provided in the availability engine 131 to properly detect and report all degradation situations in the SAN system 100. The responsible administrator applies corrective actions for the problems reported by this process in an orderly and timely manner. The SAN system 100 should be in a healthy state (no degraded situation present) before initiating any maintenance service. Or at least only the degraded component should be scheduled for service. No other components are brought down for service if the SAN system 100 is already in a degradation state.

In addition to observing the real time reports from the monitor process, it is also strongly recommended that the administrator performs the pre-maintenance check of the SAN system 100's health before beginning maintenance by using CLI commands. There are five build-in commands allowing the administrator to inspect the entire SAN system 100 in different ways.

To check the health state of the mirrored LUs, the “mirror” CLI command should be issued to view a summary of the status of all mirrored LUs and their members. All mirrors should be “operational” and all mirror members should be “OK”. Note that a mirror being “operational” doesn't imply that all members are “OK”. It is sufficient to perform this check on one availability engine 131 of the availability engine cluster.

To check the health state of the availability engine cluster, the “conmgr engine status” CLI command should be issued to each availability engine to view a summary of the status of the availability engine's connections to the other availability engines in the availability engine cluster.

To check the health state of the connection of the FC switches 121 and 122, the “port” CLI command should be issued to each availability engine 131 to view the connection status for each port of the availability engine 131 to the FC switches 121 and 122. All ports should show the expected status.

To check the health state of the connection of the storage devices 141, the “conmgr drive status” CLI command should be issued to each availability engine 131 to view a summary of the status of the connections from the availability engine 131 to each storage devices 141.

To check the health state of the connection of the server(s) 111, the “conmgr initiator status” CLI command should be issued to each availability engine to view a summary of the status of connections between the availability engine(s) 131 and server(s) 111.

The purpose of the post-maintenance check is to verify the functionality of the connections between the new or re-configured storage device 141, availability engine 131 and server 111. The connections to the storage devices 141 need to be specifically checked for read and write operations to ensure that the storage devices are not blocked by a leftover persistent reservation or by some write protection setting. Once the connections are determined to be functional, the connections should then be checked for signal quality issues.

The availability engine 131 has the ability to create the equivalent of heavy server I/O activities to the storage devices. That causes the availability engine 131 to act like an I/O generator. This function is a highly flexible tool to test the performance of the storage devices 141. The availability engine 131 is capable of simultaneously executing a large number of test threads. Different threads may be applied to the same or different LUs. Each thread performs I/O of only one size, but reads and writes may be mixed, at the proportion specified by the operator. Multiple threads can be used to generate a mixture of I/O sizes to a single LU. Each thread will maintain an operator-specified number of ongoing commands. The I/O pattern of each thread is sequential, random, or repeated to the same LBA as specified by the operator.

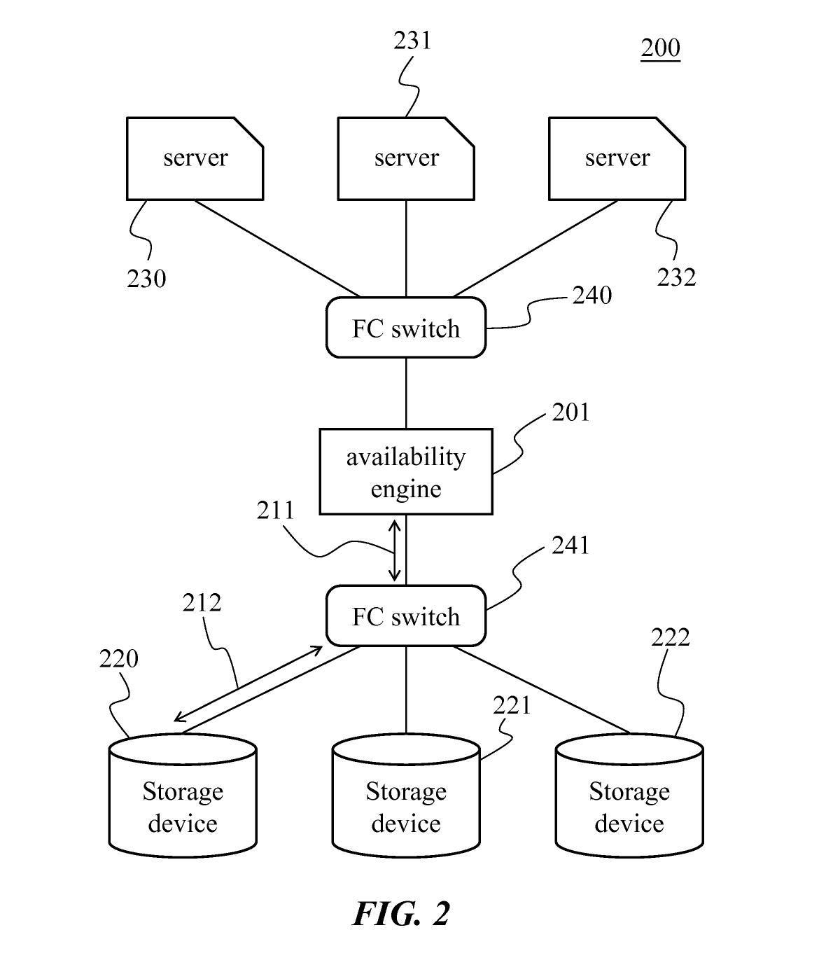

As illustrated in FIG. 2, the availability engine 201 generates the I/O 211 through the FC switch 241 which becomes the I/O 212 to storage device 220. This should be used to verify and ensure that the storage device 220, as well as all connections between the availability engine 201 and storage device 220, are healthy before returning storage device 220 to a fully operational state. It is important to verify this connectivity because this is the most common reason for failures in starting the SAN system 200 with the availability device. The availability engine will detect and report errors.

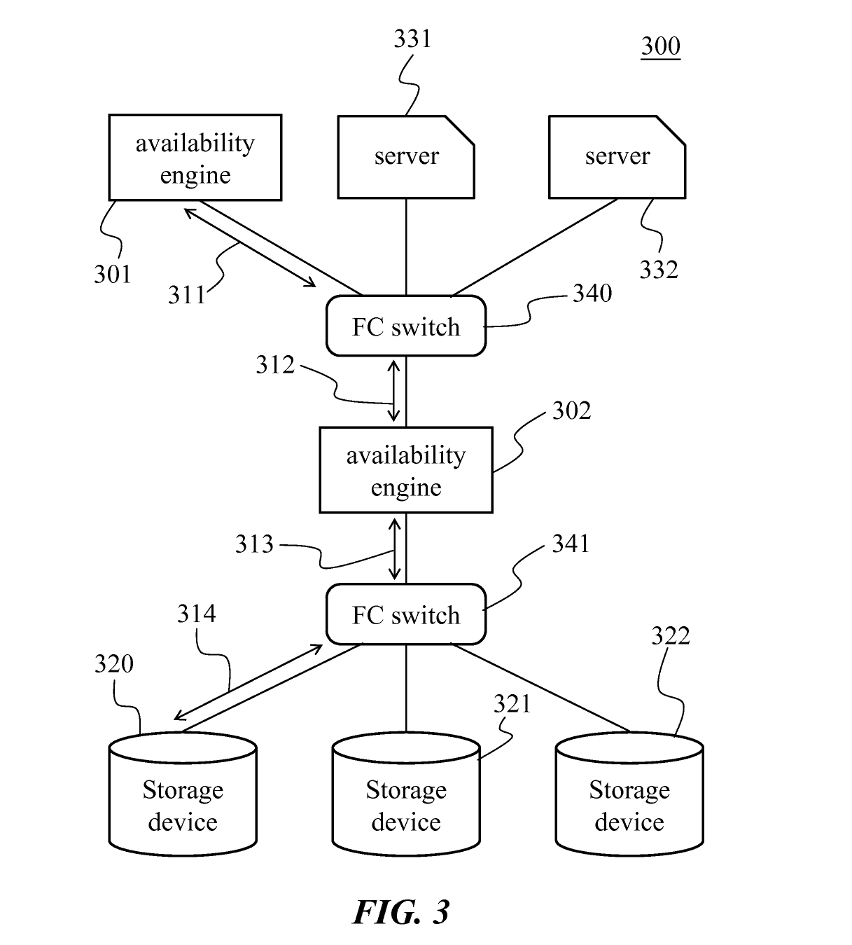

As Illustrated in FIG. 3, an availability engine 301 may also be used as a server to generate I/O 311 to the FC switch 340, which becomes the I/O 312 to the availability engine 302, then the I/O 313 to the next FC switch 341, and the final I/O 314 to the storage device 320. This behavior can test the end-to-end I/O from the server side to the storage device side within the SAN system 300 to ensure the quality of all connections and cables in the data path.

Similarly, those checks that are applied in the pre-maintenance check can also be applied in the post-maintenance check.

In a typical open system server, a default server system command timeout is normally around 30 seconds. The concept of the present invention can be summarized as follows. Applications running on the servers will not be disturbed if the I/O flow change can be settled within the system command timeout period. To enable a SAN component to be brought down for maintenance without disturbing server applications, any single point of the configuration change (e.g. offline of any host system, FC switch, availability device, or storage device causing the re-route or retry of the I/O commands) is settled within 15 seconds which is 50% of the typical command timeout. A command timeout generally will cause the application to temporarily pause during the retry, and then to be aborted if the retry fails again.

All topology changes to a SAN system have certain amounts in common. When an FC switch detects a change, it sends a notification message to each connected FC port. The availability engines will serve these notifications. The delay between the change event and the sending of the Registered State Change Notification (RSCN) messages by FC switch rarely exceeds 2 seconds based on a number of factors (e.g., model of FC switches, complexity of the current system topology, and so on).

When receiving an RSCN, the driver for a port of an availability engine queries the Directory Server function of the FC switch for a new list of port IDs that are accessible through the port. The driver compares this list with the previous list to determine which ports have arrived or departed. For a departed port, the driver takes appropriate action depending on whether the port belongs to registered components or not. For a newly arrived port, the driver must query the Directory Server again to obtain the WWPN of the port. The WWPN is then used to determine whether the port belongs to the registered components or not. These queries typically don't require any significant amount of time to complete. The whole process from receiving the RSCN to completing the re-configuration can and should be done in 5 seconds. Read/Write caching should not be employed to avoid the additional complication of cache-sync and time delay. However, the first in/first out method is used to improve the parallel processing performance.

No additional action is required when a host bus adapter (HBA) arrives which refers to an FC interface card. The availability engine makes no effort to login to the HBA. The only requirement is that the HBA must complete the login protocols some time before sending its first SCSI command to a mirrored LU. When an HBA departs, any on-going SCSI commands that it had sent to the mirrored LUs are aborted.

When a port of a storage device arrives, the connections to registered logic unit numbers (LUNs) behind the port must be prepared before any normal I/O. This requires sending a series of SCSI commands to each LU. While this activity is in progress, no new I/O from servers to mirrored LUs is started. The connection-preparation command sequence is brief and can normally be completed in a fraction of a second. If multiple new connections need to be prepared, the connection-preparation commands can be done in parallel in order to minimize the length of time that server I/O is suspended.

When a port of a storage device departs, any command sent to any of the storage device's LUs is terminated. Whenever possible, the command is reissued to the same storage device's LUs through another connection, or to the mirrored LUs in another member. The retry is transparent to the server that issued the command. This results in some delay to the completion of the command.

The departure of a port of a storage device can result in one or more LUs becoming unavailable. In contrast, the arrival of a port of a storage device can result in LUs becoming available. It is critical that all availability engines of an availability device are in agreement as to the status of all mirrored LU members. If one availability engine believes a mirrored LU member is available but another disagrees with that, the availability engine cluster will treat the mirrored LU member as unavailable. In the worst case, the synchronization of this information between availability engines can take up to about 5 seconds. This will be done after the preparation of any new storage connection is completed. When a mirrored LU member becomes available, that triggers the start of re-synchronization. This has a negligible impact on the I/O of the servers.

The departure or arrival of a port of an availability engine can result in a change in the composition of the availability engine cluster and therefore the change triggers a start of synchronization of mirrored LU members and the status information thereof. It should take no more than 5 seconds for the entire process in total. The 5 seconds does not include the time to complete the synchronization of mirrored LU members.

When a port of an availability engine departs, it can result in an availability engine dropping out of its availability engine cluster. When this happens, if the availability engine is in the process of the synchronization to a mirrored LU, the synchronization must be reassigned to another availability engine.

When a port of an availability engine arrives, it results in an availability engine joining the availability engine cluster. Whether the availability engine is joining a new availability cluster for the first time, or has been offline for a short time or for a long time, the requirement is the same. The availability engine's private database must be synchronized with the common database of the availability engine cluster.

### Embodiments

1. A SAN system including multiple components, the multiple components comprises at least one server; at least two storage devices containing unique configuration information respectively and data information respectively; at least two switches connecting to the at least one server and the at least two storage devices to form multiple data paths from the at least one server and the at least two storage devices via each of the at least two switches; and an availability device comprising two availability engines, wherein each availability engine is connected to the at least two switches, configured to detect health conditions of the at least two storage devices and configured to control the at least two switches to allow the at least one server to access at least one of the at least two storage devices through at least one of the multiple data paths according to their respective health conditions.

2. The SAN system of Embodiment 1, wherein each availability engine further comprises a software-based timer setting off according to an interrupt occurrence; and a hardware-based timer setting off according to a first predetermined time value.

3. The SAN system of any one of Embodiments 1 and 2, wherein each availability engine is configured to execute a reboot according to one of the software-based timer and the hardware-based timer, wherein each availability engine is configured to be offline when a number of the reboots is larger than a first predetermined value within a second predetermined time value.

4. The SAN system of any one of Embodiments 1 to 3, wherein any one of the two availability engines is configured to send a rejection to the at least one server when the at least one server sending an invalid request to any one of the two availability engines, wherein any one of the two availability engines is configured to block the data paths between the at least one server and the at least two switches when a frequency of sending the rejection is higher than a second predetermined value.

5. The SAN system of any one of Embodiments 1 to 4, wherein the two availability engine is connected via a standard SAN server-storage device interface to implement a heartbeat handshake.

6. The SAN system of any one of Embodiments 1 to 5, wherein any one of the two availability engines is configured to track a change of the data information existing in one of the at least two storage devices and write the change of the data information into the other one of the at least two storage devices.

7. The SAN system of any one of Embodiments 1 to 6, wherein each availability engine is configured to create a specific input/output (I/O) equivalent to one of an I/O of any one of the at least two storage devices and the at least one server's I/O.

8. A method for operating the SAN system of Embodiment 1 to bring one of the components offline comprises determining which one of the at least two storage devices should be brought offline and designating the storage device as a first device; detecting health condition of the first device; detecting health conditions of the two availability engines; detecting health conditions of the at least two switches; detecting health conditions of connections between the two availability engines and the first device; detecting health conditions of connections between the two availability engines and the at least one server; and recording the unique configuration information contained within the first device.

9. The method of Embodiment 8 further comprises generating a report containing all health conditions already obtained and the unique configuration information contained within the first device; preserving the report into the two availability engines respectively; and bring the first device offline if results of all health conditions are allowable.

10. A method for the SAN system of Embodiment 1 to bring one of the components back online comprises detecting a topology change of the SAN system; sending a notification to all components of the SAN system; recording the notification in any one of the two availability engines; and determining a new arrival port.

11. The method of Embodiment 10, wherein the determining step comprises querying the Directory Server function to obtain a new list of ports currently existing in the SAN system; comparing the new list of ports currently existing in the SAN system with an old list of ports previously existing in the SAN system and generating a difference from comparing; determining the new arrival port according to the difference; and determining a device category of the new arrival port according to a world wide port name of the new arrival port.

12. The method of any one of Embodiments 10 and 11, wherein if the new arrival port belongs to the device category of an availability engine, synchronizing the new arrival port with any one of the two availability engines.

13. The method of any one of Embodiments 10 to 12, wherein if the new arrival port belongs to the device category of a host bus adapter, completing a login protocol of the host bus adapter to the SAN system before sending a small computer command interface command.

14. The method of any one of Embodiments 10 to 13, wherein the difference can be one of a first difference and a second difference, wherein the first difference is caused by the new arrival port having the world wide port name not recorded in the SAN system before detecting the topology change of the SAN system, and the second difference is caused by the new arrival port having the world wide port name recorded in the SAN system before detecting a topology change of the SAN system.

15. The method of any one of Embodiment 10 to 14, wherein if the new arrival port belongs to the device category of a storage device, synchronizing the storage device connected to the new arrival port with any one of the two storage devices when the difference is the first difference; and re-synchronizing the storage device connected to the new arrival port with any one of the two storage devices when the difference is the second difference.

16. The method of Embodiments 10 to 15, wherein the determining step comprises comparing the notification sent to all components of the SAN system with notifications recorded in any one of the two availability engines, to determine whether a storage device connected to the new arrival port is the storage device which was once connected to the SAN system, or the storage device connected to the new arrival port is the storage device which was never connected to the SAN system.

17. The method of Embodiments 10 to 16, further comprises synchronizing the storage device connected to the new arrival port with any one of the two storage devices if the storage device connected to the new arrival port is the storage device which was never connected to the SAN system; and re-synchronizing the storage device connected to the new arrival port with any one of the two storage devices if the storage device connected to the new arrival port is the storage device which was once connected to the SAN system.

18. The method of any one of Embodiments 10 to 17, wherein the re-synchronizing step is based on bitmaps of the storage device connected to the new arrival port and any one of the two storage devices and performed by a designated availability engine.

19. The method of any one of Embodiments 10 to 18, wherein the re-synchronizing step comprises selecting a first data block in the storage device connected to the new arrival port and determining a second data block corresponding to the first data block in any one of the two storage devices; sending a first message to the other availability engine to lock the first data block and the second data block; waiting for a writing command before sending the first message to be performed; sending a second message to the designated availability engine after the writing command is performed to acknowledge that the first data block and the second data block are locked; replicating the first data block to overwriting the second data block; and sending an unlock message to the other availability engine to unlock the first data block in the storage device connected to the new arrival port and the first data block in any one of the two storage devices.

While the invention has been described in terms of what is presently considered to be the most practical and preferred Embodiments, it is to be understood that the invention does not need to be limited to the disclosed Embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A storage area network (SAN) system including multiple components, the multiple components comprising:
at least one server;
at least two storage devices containing unique configuration information respectively and data information respectively;
at least two switches connecting to the at least one server and the at least two storage devices to form multiple data paths from the at least one server and the at least two storage devices via each of the at least two switches; and
an availability device comprising two availability engines, wherein each availability engine is connected to the at least two switches, configured to detect health conditions of the at least two storage devices and configured to control the at least two switches to allow the at least one server to access at least one of the at least two storage devices through at least one of the multiple data paths according to their respective health conditions.

2. The SAN system according to claim 1, wherein each availability engine further comprises:
a software-based timer setting off according to an interrupt occurrence; and
a hardware-based timer setting off according to a first predetermined time value.

3. The SAN system according to claim 2, wherein each availability engine is configured to execute a reboot according to one of the software-based timer and the hardware-based timer, wherein each availability engine is configured to be offline when a number of the reboot is larger than a first predetermined value within a second predetermined time value.

4. The SAN system according to claim 2, wherein any one of the two availability engines is configured to send a rejection to the at least one server when the at least one server sending an invalid request to any one of the two availability engines, wherein any one of the two availability engines is configured to block the data paths between the at least one server and the at least two switches when a frequency of sending the rejection is higher than a second predetermined value.

5. The SAN system according to claim 2, wherein the two availability engines are connected via a standard SAN server-storage device interface to implement a heartbeat handshake.

6. The SAN system according to claim 2, wherein any one of the two availability engines is configured to track a change of the data information existing in one of the at least two storage devices and write the change of the data information into the other one of the at least two storage devices.

7. The SAN system according to claim 2, wherein each availability engine is configured to create a specific input/output (I/O) equivalent to one of an I/O of any one of the at least two storage devices and the at least one server's I/O.

8. A method for operating the storage area network (SAN) system of claim 1 to bring one of the components offline comprising:
determining which one of the at least two storage devices should be brought offline and designating the storage device as a first device;
detecting health condition of the first device;
detecting health conditions of the two availability engines;
detecting health conditions of the at least two switches;
detecting health conditions of connections between the two availability engines and the first device;
detecting health conditions of connections between the two availability engines and the at least one server; and
recording the unique configuration information contained within the first device.

9. The method according to claim 8, further comprising:
generating a report containing all health conditions already obtained and the unique configuration information contained within the first device;
preserving the report into the two availability engines respectively; and
bring the first device offline if results of all health conditions are allowable.

10. A method for the storage area network (SAN) system of claim 1 to bring one of the components back online comprising:
detecting a topology change of the SAN system;
sending a notification to all components of the SAN system;
recording the notification in any one of the two availability engines; and
determining a new arrival port.

11. The method according to the claim 10, wherein the determining step comprises:
querying the Directory Server function to obtain a new list of ports currently existing in the SAN system;
comparing the new list of ports currently existing in the SAN system with an old list of ports previously existing in the SAN system and generating a difference from comparing;
determining the new arrival port according to the difference; and
determining a device category of the new arrival port according to a world wide port name of the new arrival port.

12. The method according to claim 11, wherein if the new arrival port belongs to the device category of an availability engine, synchronizing the new arrival port with any one of the two availability engines.

13. The method according to claim 11, wherein if the new arrival port belongs to the device category of a host bus adapter, completing a login protocol of the host bus adapter to the SAN system before sending a small computer command interface command.

14. The method according to claim 11, wherein the difference can be one of a first difference and a second difference, wherein the first difference is caused by the new arrival port having the world wide port name not recorded in the SAN system before detecting the topology change of the SAN system, and the second difference is caused by the new arrival port having the world wide port name recorded in the SAN system before detecting a topology change of the SAN system.

15. The method according to claim 14, wherein if the new arrival port belongs to the device category of a storage device,
synchronizing the storage device connected to the new arrival port with any one of the two storage devices when the difference is the first difference; and
re-synchronizing the storage device connected to the new arrival port with any one of the two storage devices when the difference is the second difference.

16. The method according to claim 10, wherein the determining step comprises:
comparing the notification sent to all components of the SAN system with notifications recorded in any one of the two availability engines, to determine whether a storage device connected to the new arrival port is the storage device which was once connected to the SAN system, or the storage device connected to the new arrival port is the storage device which was never connected to the SAN system.

17. The method according to claim 16, further comprising:
synchronizing the storage device connected to the new arrival port with any one of the two storage devices if the storage device connected to the new arrival port is the storage device which was never connected to the SAN system; and
re-synchronizing the storage device connected to the new arrival port with any one of the two storage devices if the storage device connected to the new arrival port is the storage device which was once connected to the SAN system.

18. The method according to any one of claim 15 or 17, wherein the re-synchronizing step is based on bitmaps of the storage device connected to the new arrival port and any one of the two storage devices and performed by a designated availability engine.

19. The method according to claim 18, wherein the re-synchronizing step comprises:
selecting a first data block in the storage device connected to the new arrival port and determining a second data block corresponding to the first data block in any one of the two storage devices;
sending a first message to the other availability engine to lock the first data block and the second data block;
waiting for a writing command before sending the first message to be performed;
sending a second message to the designated availability engine after the writing command is performed to acknowledge that the first data block and the second data block are locked;
replicating the first data block to overwriting the second data block; and
sending an unlock message to the other availability engine to unlock the first data block in the storage device connected to the new arrival port and the first data block in any one of the two storage devices.
